(19) United States
(12) Patent Application Publication
(10) Pub. No.: US 2019/0204606 A1
(43) Pub. Date: Jul. 4, 2019

(54) VIRTUAL REALITY HEADSET THAT ENABLES USE WITH A REAR HEAD SUPPORT

(71) Applicant: Ariadne's Thread (USA), Inc., Solana Beach, CA (US)

(72) Inventors: Allen Yang, San Ramon, CA (US); Jun Zhao, Solana Beach, CA (US); Xianqin CHEN, Beijing (CN); Jia XU, Beijing (CN); Yunlong ZHANG, Beijing (CN)

(73) Assignee: Ariadne's Thread (USA), Inc., Solana Beach, CA (US)

(21) Appl. No.: 15/861,658

(22) Filed: Jan. 3, 2018

(51) Int. Cl. G02B 27/01; G06T 19/00

(52) U.S. Cl. CPC G02B 27/0176; G02B 2027/0178; G06T 19/006

(57) ABSTRACT

A virtual or augmented reality headset that enables use while leaning backwards against a head support or lying down. The front goggles of the headset are relatively small and comfortable compared to typical bulky, heavy headsets that restrict head movement. The goggles are connected to a headband that is constructed from a soft, compliant material to function as a pillow when leaning the head back against a support. The size and weight of the headset may be further reduced by moving the batteries or other components to a separate module that may be for example worn around the neck. The goggles or headband may also contain speakers that direct sound to the ears via integrated directional sound paths while leaving the ears uncovered. The goggles may have an automated mechanism to adjust the distance between left and right lenses to match a user's intraocular distance.

### BACKGROUND OF THE INVENTION

### Field of the Invention

One or more embodiments of the invention are related to the field of virtual reality, augmented reality and mixed reality systems, wherein any reference herein to virtual reality includes augmented reality and mixed reality uses. More particularly, but not by way of limitation, one or more embodiments of the invention enable a virtual reality headset that enables a user to comfortably rest his or her head backwards on a rear head support, such as for example a chair or a pillow and for example rotate the user's head while engaging the rear head support.

### Description of the Related Art

Virtual reality headsets known in the art are typically large and bulky. Because of their size and weight, they are often uncomfortable for a user to wear for an extended period of time. The large form factor for these headsets also generally restricts the user to using the headset with the head leaning forward. In particular, headsets usually wrap around a user's head and consist of rigid materials. These existing headset designs make it impossible or uncomfortable for a user to lean the head backward into a rear head support, such as chair, pillow, or bed. This limitation means that users cannot use existing headsets while lying down in a bed, for example, or while leaning back into an airplane seat or a car set with a head support.

For at least the limitations described above there is a need for a virtual reality headset that enables use with a rear head support.

### BRIEF SUMMARY OF THE INVENTION

One or more embodiments described in the specification are related to a virtual reality headset that enables use with a rear head support. Embodiments of the system may have a physical configuration that combines relatively small front goggles with a comfortable, compliant rear headband, thereby enabling a user to use the system while leaning backwards or lying down. Embodiments may include headsets that support virtual reality, augmented reality, mixed reality, or any combinations thereof

One or more embodiments of the invention may include a goggle assembly configured to conform to the user's front face, a headband configured to conform to the back of the user's head, and left and right connectors coupling the goggles to the headband. The goggle assembly may have a housing that extends no further back than the front of the user's ears. Within the housing may be one or more displays, and left and right lenses in front of the user's eyes.

The headband may be configured for a snug but comfortable fit that also allows the user to rest the head on a rear head support. For example, one or more embodiments may have a relatively thick center portion of the headband at the back of the user's head, which may function as a pillow. All or part of the headband may be made of a compliant material, such as a foam, sponge, or gel. The compliant material may be relatively soft, having for example an Indentation Load Deflection rating of 10 pounds or less.

The connectors that couple the headband to the goggles may be connected to expansion springs that allow the headset to accommodate different head sizes. Expansion springs may be integrated into either or both of the goggles and the headband.

One or more embodiments may incorporate one or more speakers, such as left and right speakers for stereo audio. In one or more embodiments, the speakers may not cover or contact the ears, but may instead be integrated into the goggles or the headband. This configuration may increase the user's comfort and range of motion, and may allow the user to rest the side of the head against a support. Sound paths may be integrated into either or both of the goggles and the headband to direct sound from the speakers towards the user's ears. In one or more embodiments, the sound paths may also function as acoustic cavity resonators to amplify or modify certain audio frequencies. One or more embodiments may support haptic feedback by incorporating one or more vibration actuators into the goggles, the headband, or both.

In one or more embodiments, the goggles may have an intraocular distance adjustment mechanism that may be used to adjust the distance between the left lens and the right lens in the goggles. The intraocular distance adjustment mechanism may be manual or it may be partially or fully automatic. For example, in one or more embodiments, the intraocular distance adjustment mechanism may use previously stored information for the desired intraocular distance for a specific user, and it may actuate relative motion between the lenses to set the inter-lens distance to this desired value for the user. The adjustment mechanism may for example include a motor coupled to a worm drive that is coupled to the left and right lenses. One or more embodiments may also provide support for measuring the intraocular distance for a user and storing this data in a database, so that the intraocular distance for this user can be automatically set in the future when this user uses the headset.

One or more embodiments may include a power supply assembly that is physically separated from the goggles and the headband. Use of a separate power supply assembly may for example reduce the weight and size of the components mounted on the user's head, further increasing comfort and mobility for the user. The power supply assembly may for example contain batteries or another source of power; it may be connected to the headband or the goggles via a power cable. The power supply assembly may be configured to be attached to any part of the user's body. For example, in one or more embodiments the power supply assembly may be integrated into a collar that may be worn around the user's neck.

### BRIEF DESCRIPTION OF THE DRAWINGS

The above and other aspects, features and advantages of the invention will be more apparent from the following more particular description thereof, presented in conjunction with the following drawings wherein:

FIG. 1 shows a top front perspective view of an embodiment of the invention, illustrating the relatively small front goggles that conform to a user's face, and the compliant, comfortable rear headband.

FIG. 2 shows placement of the embodiment of FIG. 1 on the head of a user.

FIG. 3 shows the user leaning backward into a chair while wearing the headset.

FIG. 4 shows a rear view of the embodiment of FIG. 1, illustrating the lenses housed within the goggles.

FIG. 5 shows goggle internal components of an embodiment of the invention.

FIG. 5A shows an embodiment of the invention that provides automatic adjustment of the interocular distance between lenses based on a user profile.

FIG. 6 shows an embodiment of the invention that incorporates speakers coupled to a directional, amplifying sound path, and vibration actuators for haptic feedback.

FIG. 7A shows an embodiment of the invention with expansion springs in the connection between the headband and the goggles, thereby allowing the headset to be used with different sized heads.

FIG. 7B shows the embodiment of FIG. 7A used on a small head, and FIG. 7C shows the embodiment of FIG. 7A used on a large head.

FIG. 8 shows an embodiment of the invention with a power supply assembly integrated into a neck collar, thereby reducing the weight and size of the headset.

### DETAILED DESCRIPTION OF THE INVENTION

A virtual reality headset that enables use with a rear head support will now be described. In the following exemplary description, numerous specific details are set forth in order to provide a more thorough understanding of embodiments of the invention. It will be apparent, however, to an artisan of ordinary skill that the present invention may be practiced without incorporating all aspects of the specific details described herein. In other instances, specific features, quantities, or measurements well known to those of ordinary skill in the art have not been described in detail so as not to obscure the invention. Readers should note that although examples of the invention are set forth herein, the claims, and the full scope of any equivalents, are what define the metes and bounds of the invention.

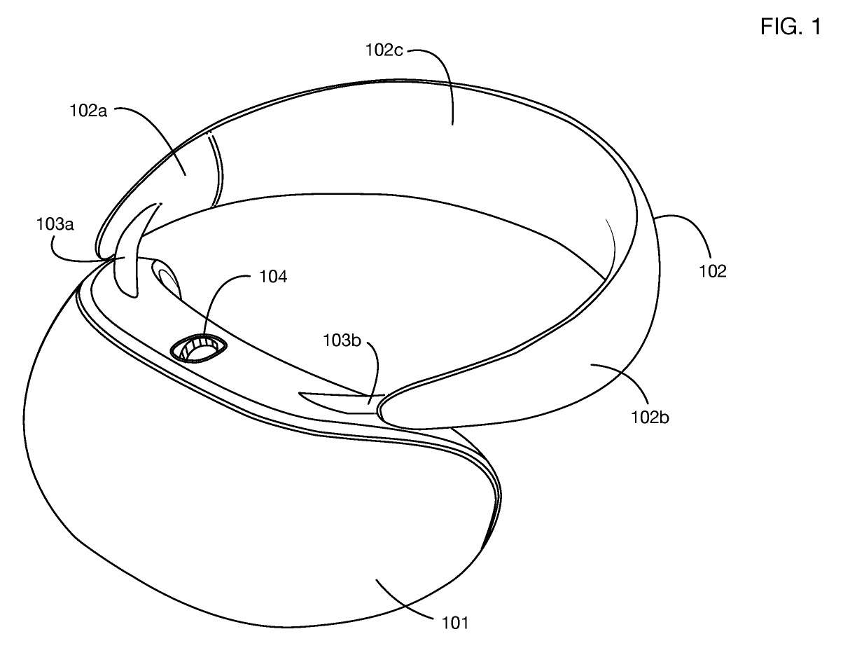

FIG. 1 illustrates an embodiment of the invention that includes front goggles 101 and a headband 102. Goggles 101 may contain for example one or more displays and one or more lenses through which the user views a virtual reality environment, an augmented reality environment, or a mixed reality environment. Other electronics typical of virtual reality or augmented/mixed reality systems, such as for example microprocessors, network interfaces, and inertial sensors, may be integrated into goggles 101 or into headband 102. In one or more embodiments, one or both of goggles 101 and headband 102 may incorporate cameras, so that the user may view real scenes or augmented reality scenes in addition to or instead of virtual reality scenes. Goggles 101 may be opaque, transparent, or partially transparent. Headband 102 may be attached to goggles 101 for example via right side connector 103a and left side connector 103b. In one or more embodiments, the connections between the goggles and the headband may be detachable, so that users may for example replace a headband or use different headbands with the same goggles in different situations.

In one or more embodiments, headband 102 may be formed from one or more soft, compliant materials to maximize user comfort. The headband may function as a pillow, allowing the user to rest the head backwards against a support surface such as a chair or a bed. For example, the headband may have a foam, sponge, or gel interior, and a cloth or leather exterior surface. In one or more embodiments, the interior of the headband may contain air pockets or be inflatable. In one or more embodiments, the headband may be sufficiently soft and compliant to have an Indentation Load Rating of between 0-1 pounds, 1-5 pounds, 5-10 pounds or less; this rating may apply for the entire headband or for a portion such as the back segment 102c. In one or more embodiments, the thickness of the headband may be greater in the back segment 102c than in the side segments 102a and 102b. For user comfort and to support resting the head against supports, the headset may be configured so that any large, rigid components are not located in the headband. In one or more embodiments, the headband may contain some electronics, but these components may be relatively small and may be surrounded for example by foam so that user comfort is not compromised. The shape and materials of headband 102 may be selected to provide an optimal balance between a secure fit and user comfort.

In one or more embodiments, front goggles 101 may be shaped to conform closely to the user's face. The materials of the inner surface of the goggles may be compliant to maximize comfort and fit. For example, the inner surface of the goggles that contacts the user's face may be made of cloth, foam, or a soft plastic or rubber. The shape of the goggles may be configured to fit closely and snugly to the user's face so that the goggles do not slip when the user turns the head or rests the head against a support. In one or more embodiments, the distance that goggles 101 extend outward beyond the side of the head are minimal and the thickness of side segments 102a and 102b are such that the user may effectively rotate the user's head a full 180 degrees from side to side while supported from the rear, wherein where rotated the side segments are in contact with the rear support. This is unknown in the art as virtual reality goggles are made for vertical use and protrude from the side portion of the head such that rotation through 180 degrees is not possible.

The embodiment of FIG. 1 includes an interocular adjustment mechanism 104. This mechanism may be used for example to change the distance between the lenses in front of the user's two eyes. The illustrative mechanism 104 is a wheel, but one or more embodiments may incorporate any type of mechanisms to adjust interocular distance or any other parameters, including for example wheels, sliders, buttons, latches, or screws. One or more embodiments may have adjustment mechanisms to adjust the fit of the goggles onto the face, to ensure a snug fit or to maximize comfort, for example.

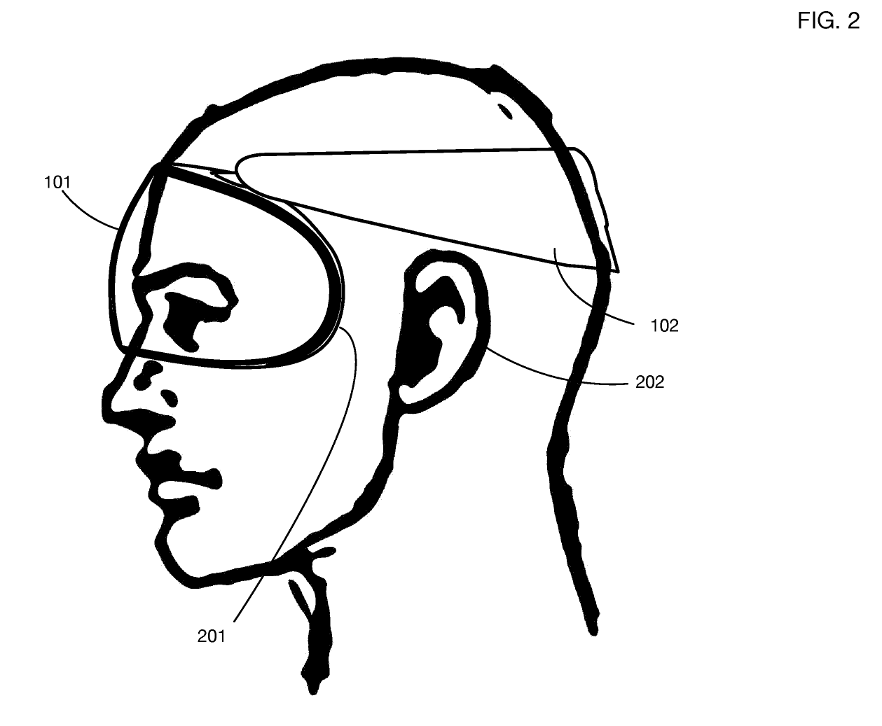

FIG. 2 shows the embodiment of FIG. 1 worn by a user. (The goggles and headband are shown as transparent in this and other drawings for illustration only; typically, these components are opaque.) Goggles 101 fit snugly around the user's front face, but in this embodiment they do not extend beyond the front of the user's ears. For example, in the embodiment shown in FIG. 2, left edge 201 of goggles 101 is in front of the left ear 202. Because the goggles are relatively small, the side and back of the user's head is unencumbered. The back of the head is supported by the compliant headband 102; the side of the head is relatively open except for a strip of the headband. Therefore, the user can rest his or her head against a support while using the headset. The configuration of the system even supports use while resting the side of the head against a support such as a pillow, since the ears are uncovered by the system components.

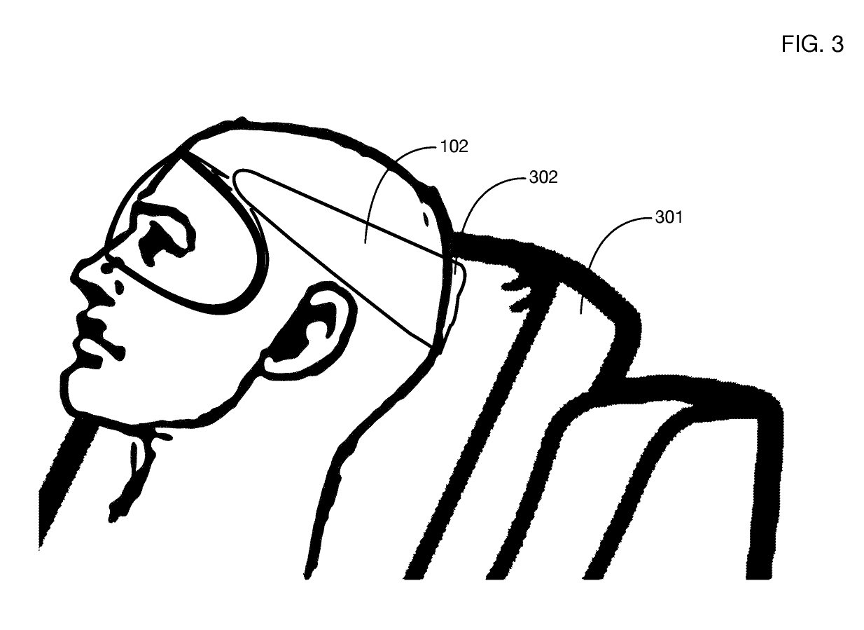

FIG. 3 shows the system of FIG. 2 in use with the user resting backwards against a chair 301. The back portion 302 of headband 102 is compliant and functions in part as a pillow to enhance user comfort. The user can also turn the head left and right while leaning back into support 301.

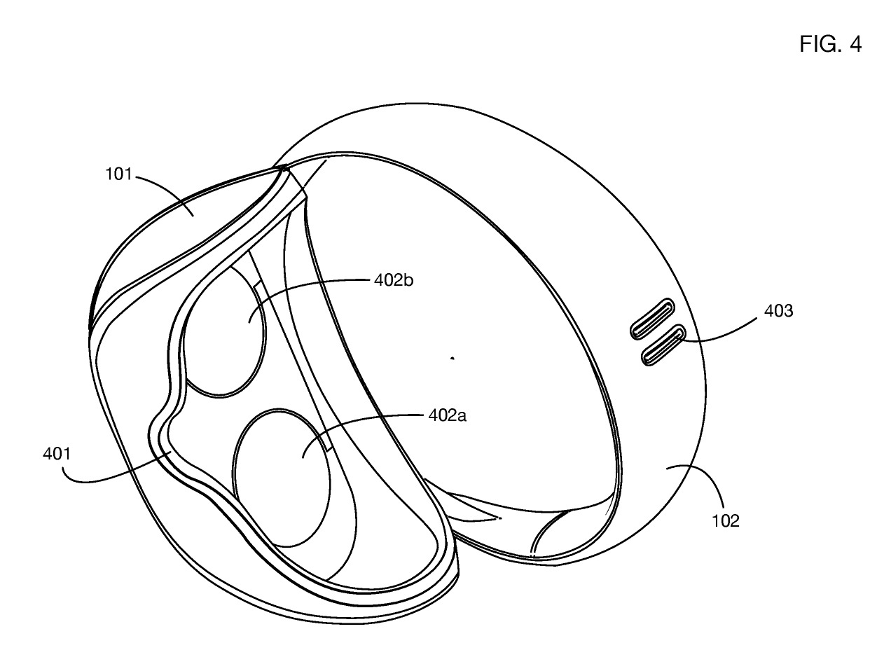

FIG. 4 shows another view of the embodiment of FIG. 1, showing the inside and bottom surface of goggles 101. Goggles 101 have an indentation 401 to conform to the user's nose. The goggles contain one or more displays, and two lenses 402a and 402b positioned in front of the user's right and left eyes, respectively. The display or displays are located between the lenses and the outer (front) surface of the goggles. The goggles may also contain other electronic components as needed.

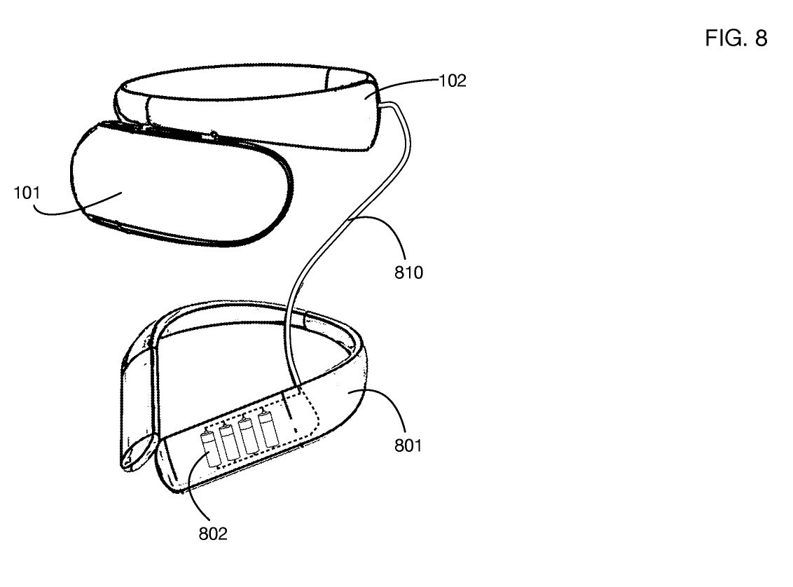

In the embodiment shown in FIG. 4, headband 102 includes a power connection port 403. This power connection port allows power to be provided external to the headset, which may for example reduce the size and weight of the headset. This option of an external power source is described below with respect to FIG. 8.

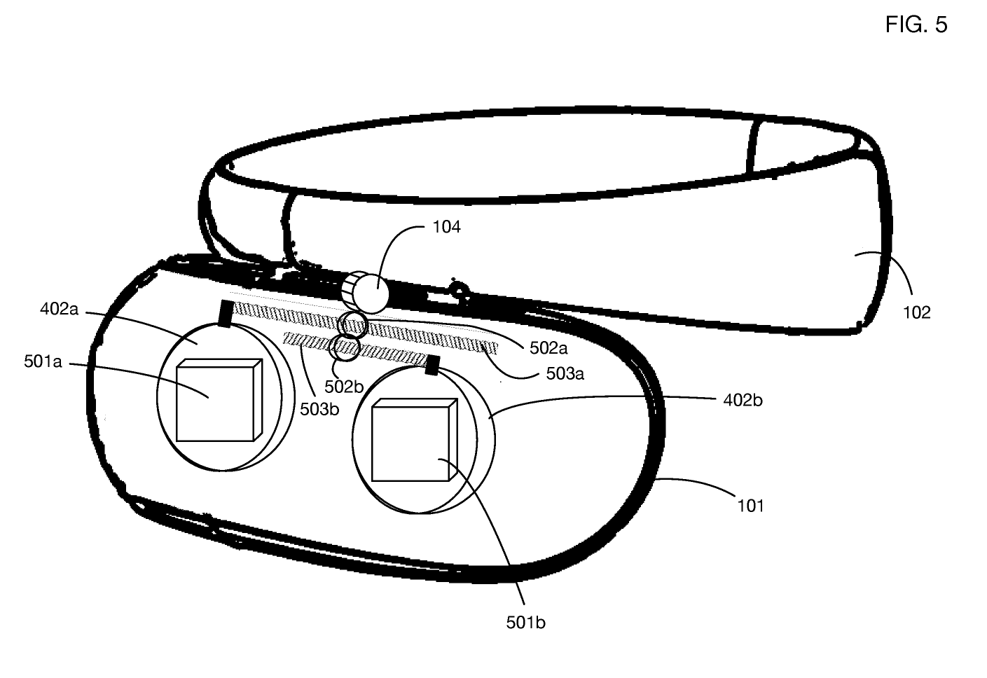

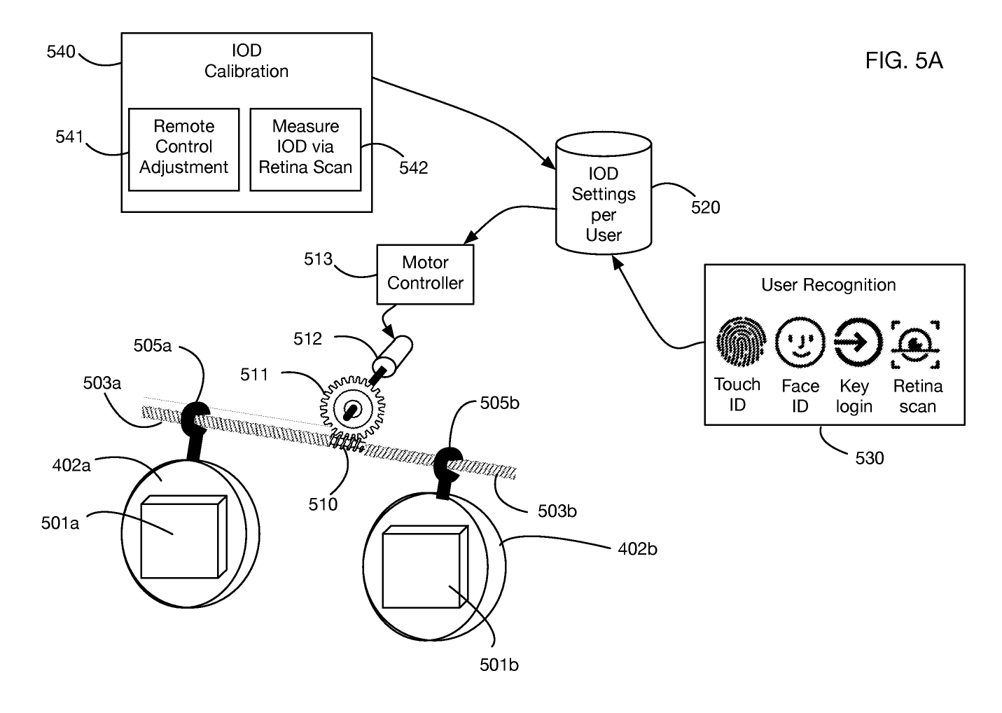

FIG. 5 shows selected illustrative internal components of the goggles for an embodiment of the invention. In this illustrative embodiment, the system has two separate displays 501a and 501b, one for each eye. The displays are attached to the lenses 402a and 402b, respectively. Other embodiments of the system may have only a single display in a fixed position, with the lenses providing different viewports into the shared display. FIG. 5 also shows an illustrative mechanism for adjustment of the interocular distance. Wheel 104 is coupled to an internally threaded gear 502 that rotates and moves a threaded screw 503a attached to right lens 402a. Similarly gear 502a is coupled to a second internally threaded gear 502b that rotates and moves a threaded screw 503b attached to left lens 402b. This mechanism is illustrative; one or more embodiments may use any type of mechanism or mechanisms to adjust the interocular distance between the lenses.

The interocular distance adjustment mechanism illustrated in FIG. 5 supports a manual adjustment performed by the user, using wheel 104. One or more embodiments may support an automated adjustment mechanism for the distance between lenses. An automated adjustment may allow multiple users to use a shared headset, for example, with the headset automatically changing the inter-lens distance to conform to each user's interocular distance. FIG. 5A shows an illustrative embodiment with an automated lens distance adjustment mechanism. A motor 512, such as a servomotor for example, drives the lenses 402a and 402b apart or closer together. In the mechanism shown in FIG. 5A, motor 512 drives a worm wheel 511 coupled to worm screw 510. The worm screw 510 is coupled to the threaded shafts 503a and 503b, which may for example be threaded in opposite orientations. An internally threaded nut 505a travels linearly along shaft 503a as it rotates, moving lens 402a in or out; similarly, internally threaded nut 505b travels linearly along shaft 503b as it rotates, moving lens 402b in or out. Actuation of motor 512 in one direction moves the lenses closer together; actuation in the other direction moves the lenses further apart. In one or more embodiments the gearing, screw pitch, and motor positioning resolution may be configured to provide distance adjustments within one micron or less. The mechanism shown in FIG. 5A is illustrative; one or more embodiments may use any type or types of mechanism to couple one or more actuators to the lenses to change the distance between them. For example, distance adjustment mechanisms may use gears, pulleys, belts, linkages, or any combination thereof. A single actuator may drive both lenses (as in FIG. 5A), or separate actuators may be used for each lens.

In one or more embodiments, the motor 512 and the mechanism for moving the lenses may be controlled so that the inter-lens distance is adjusted automatically to the correct distance when a user starts using the headset. For example, a database 520 may contain the correct interocular distance (IOD) for a collection of users. This database may be stored on the headset itself (for example in memory accessible to the headset electronics), or may be stored remotely from headset. The database may be any information in any format stored on any medium or media that associates a user identifier with an intraocular distance. When a user begins using the headset, a user recognition procedure 530 may be performed to identify the user. One or more embodiments may use any procedure to identify a user, including for example, without limitation, touch ID (for example using a fingerprint reader), face ID (for example using a camera with face recognition capabilities), key login using a token or password (or both), and retina scanning integrated into the headset goggles. User recognition may be performed locally on the headset, or remotely from the headset. For example, the virtual reality headset may have an integrated fingerprint reader, facial recognition camera, or retina scanner. If user recognition is performed remotely from the headset, data may be transferred to the headset for example over a network connection to generate the necessary motor controls to adjust the IOD.

Once user recognition 530 is performed, the IOD associated with the user is obtained from database 520, and is transmitted to motor controller 513 that actuates motor 512 to move the lenses to this IOD. The motor controller 513 may be for example embedded in hardware and software on the headset. Alternatively, portions of motor control logic may be executed remotely from the headset, and low-level motor controls (such as voltages or RPMs) may be transmitted to the headset for execution by motor 512. One or more embodiments may perform any or all of the functions shown in FIG. 5A either on the headset or remote from the headset, or use any combination of local headset operation and remote operation.

In one or more embodiments, the system may also provide support for constructing the database 520. For example, an IOD calibration procedure 540 may be used for a new user to determine that user's IOD for database 520. IOD calibration may for example be performed using remote control adjustment 541, wherein a calibration image is displayed on the headset and the user remotely controls the IOD adjustment mechanism to adjust the lens distance to the optimal setting. For example, the user may use a computer, tablet, phone, or similar device to modify the IOD and to indicate when the distance is optimal. Another IOD calibration procedure that may be supported in one or more embodiments is measurement of the IOD 542, using for example, a retina scan integrated into the headset. For example, the IOD may be measured with a laser or with any other measurement sensor or sensors. Manual adjustment such as procedure 541 and automated measurement such as procedure 542 may be combined in one or more embodiments; for example, the system may make an initial measurement of the IOD, and the user may thereafter make fine adjustments using remote input.

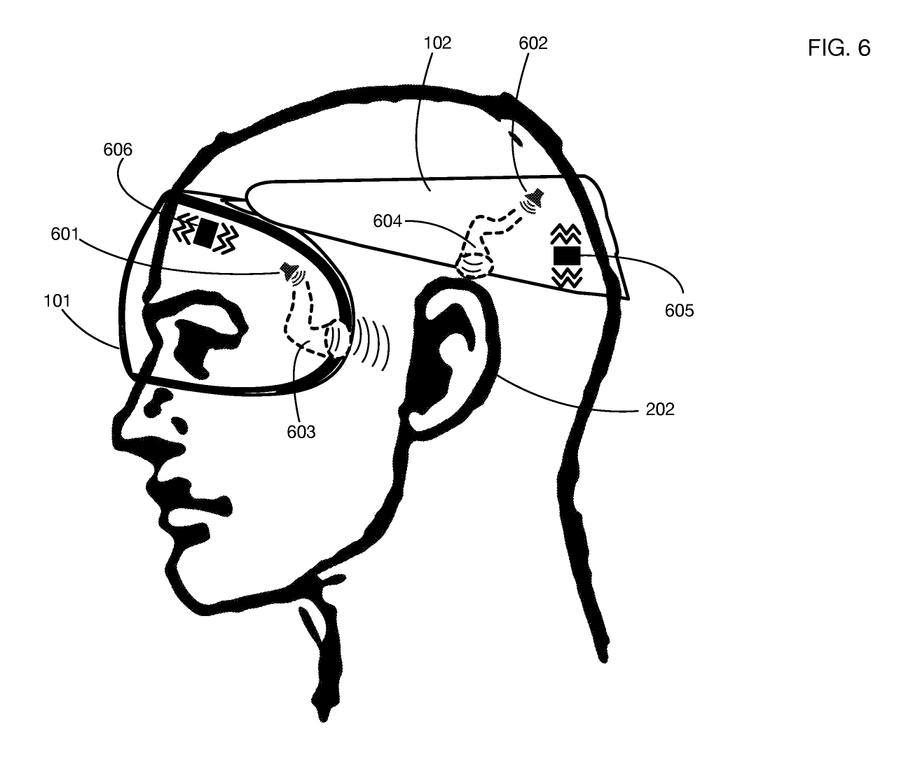

In one or more embodiments, one or both of the goggles and the headset may include components for generating sound or vibration. FIG. 6 shows an illustrative embodiment with both sound and vibration components. For sound, virtual reality or augmented/mixed reality headsets often incorporate headphones that cover the user's ears. One or more embodiments of the invention may use this approach; however, in order to minimize the size, weight, and potential discomfort of the system, one or more embodiments may use a different approach that locates speakers in the goggles or the headband (or both), and directs sound from these areas towards the user's ears. In the embodiment of FIG. 6, speaker 601 is located in goggles 101, and speaker 602 is located in headband 102. One or more embodiments may have speakers in either or both of the goggles and headband. The speakers shown for illustration are for the left ear; in one or more embodiments, there may be separate speakers for the left ear and the right ear. (One or more embodiments may have a single speaker, and may direct sound to either or both ears from this single speaker.) Speakers may be located and oriented so that sound propagates towards the desired ear or ears. In one or more embodiments, the propagation of sound from the speaker or speakers towards the ear or ears may be enhanced by integrating one or more sound paths into the headset itself. For example, the embodiment of FIG. 6 has sound path 603 directing sound from speaker 601 towards the left ear 202, and has sound path 604 directing sound from speaker 602 towards the left ear 202. The sound paths may be simple cavities or they may incorporate various baffles, acoustic reflective or absorbing materials, or other mechanisms as desired. The sound paths may enhance the directionality of the audio signal. By using directional sound paths, speakers may be placed in convenient locations to reduce the overall bulk and complexity of the headset, while still providing high quality audio that reaches the ears. In one or more embodiments, the sound path or paths may further serve to enhance or amplify selected audio frequencies; for example, they may act as acoustic cavity resonators for bass or for other selected frequencies. The shape and size of the sound paths (as well as the materials employed) may be tuned for any desired frequency response.

One or more embodiments of the invention may also incorporate haptic devices such as vibration actuators into the headset. These actuators may be incorporated into either or both of the goggles and the headband. FIG. 6 shows a vibration actuator 605 integrated into headband 102, and another vibration actuator 606 integrated into goggles 101.

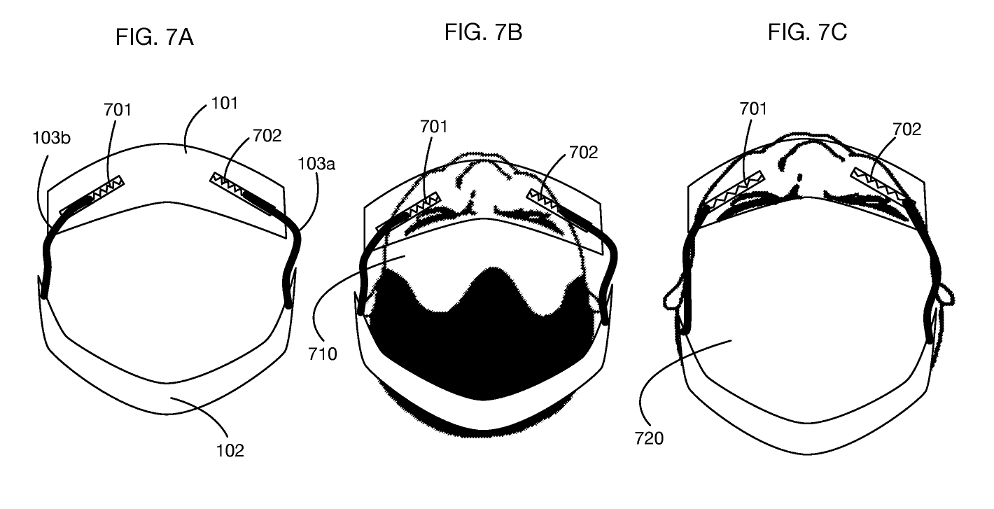

In one or more embodiments, the coupling between the front goggles and the headband may be configured to support a secure fit for different head sizes. FIG. 7A illustrates a top view of an embodiment that incorporates expansion springs into the coupling between the goggles and the connectors attached to the headband. Connector 103a is attached to the right edge of the headband 102, and to an expansion spring 702 that is attached to the right side of goggles 101. Similarly, connector 103b is attached to the left edge of the headband 102, and to an expansion spring 701 that is attached to the left side of goggles 101. These expansion springs 701 and 702 allow the headset to accommodate different size heads. In one or more embodiments, the spring or springs may be replaced by other stretchable materials such as for example an elastomer. In one or more embodiments, the spring or springs may be located on the headband instead of or in addition to the goggles. FIGS. 7B and 7C illustrate the function of the expansion springs: in FIG. 7B, a user with a relatively small head 710 wears the headset; in FIG. 7C a user with a larger head 720 wears the headset, and the springs 701 and 702 expand to accommodate the larger head. One or more embodiments may incorporate user adjustments instead of or in addition to springs or other flexible couplings to adjust the fit to different head shapes and sizes.

In one or more embodiments of the invention, power supplies such as batteries or power adapters may be located off the headset itself in order to reduce the size and weight of the headset. For example, a power supply assembly may be integrated into a component that attaches to a part of the user's body other than the head, and a power supply cable may provide power from the power supply assembly to the headset. FIG. 8 shows an illustrative embodiment with a collar assembly 801 configured to be worn for example around a user's neck. The collar 801 may for example be formed from flexible and compliant material for comfort and fit. Collar 801 contains batteries 802, and a power cable 810 supplies power from the collar 801 to the headset. In this illustrative embodiment, the power cable 810 connects to the back of headband 102 (for example to a connection such as port 403 shown in FIG. 4). In one or more embodiments, a power cable or cables may connect to the headset at any point of the headband, the goggles, or both. One or more embodiments may use power supply assemblies configured to be worn on or connected to other parts of the user's body or clothing; for example, without limitation, power supplies may be worn around the arm, wrist, waist, or placed in or clipped to a pocket, belt, or any article of clothing. Instead of or in addition to containing batteries 802, the power supply assembly may have an AC-to-DC power adapter that may be used for recharging batteries or to supply power directly to the headset from an AC power source.

In one or more embodiments, components other than or in addition to batteries or other power supply elements may be located off the headset, potentially further reducing the headset's weight and size. For example, collar 801 or a similar assembly located off the headset may contain items such as speakers, vibration actuators, processors, other sensors such as inertial sensors or cameras, communications interfaces, microphones, or smell generation systems. In one or more embodiments both the headset and the off-head assembly may include selected components; for example, speakers or vibration actuators may be located both in the headset and on collar 801.

While the invention herein disclosed has been described by means of specific embodiments and applications thereof, numerous modifications and variations could be made thereto by those skilled in the art without departing from the scope of the invention set forth in the claims.

What is claimed is:

1. A virtual reality headset that enables use with a rear head support, comprising:
a goggle assembly comprising
a housing configured to conform to a user's face, wherein a left edge of said housing is in front of said user's left ear, and a right edge of said housing is in front of said user's right ear;
at least one display coupled to an inner surface of said housing and located between said housing and said user's face;
a left lens coupled to said housing and located between said at least one display and a left eye of said user; and,
a right lens coupled to said housing and located between said at least one display and a right eye of said user;
a headband configured to conform to a back side of said user's head and secure said goggle assembly to said user's head when said user's head is supported from the rear or side;
a left connector coupled to a left side of said headband and to a left side of said goggle assembly; and,
a right connector coupled to a right side of said headband and to a right side of said goggle assembly.

2. The system of claim 1, wherein
said headband comprises a left side segment, a center back segment that contacts a back of said user's head, and a right side segment; and,
said center back segment is thicker than said left side segment and is thicker than said right side segment.

3. The system of claim 1, wherein said headband comprises a compliant material.

4. The system of claim 3, wherein said compliant material comprises an Indentation Load Deflection rating of 10 pounds or less.

5. The system of claim 1, wherein
said goggle assembly further comprises a left side expansion spring and a right side expansion spring;
said left connector is coupled to said left side expansion spring; and,
said right connector is coupled to said right side expansion spring.

6. The system of claim 1, further comprising:
a left speaker coupled to said left side of said goggle assembly or to said left side of said headband; and,
a right speaker coupled to said right side of said goggle assembly or to said right side of said headband.

7. The system of claim 6, wherein
said left speaker does not contact or cover said user's left ear; and,
said right speaker does not contact or cover said user's right ear.

8. The system of claim 7, further comprising:
a left side sound path located in said left side of said goggle assembly or said left side of said headband and configured to direct audio from said left speaker towards said user's left ear; and,
a right side sound path located in said right side of said goggle assembly or said right side of said headband and configured to direct audio from said right speaker towards said user's right ear.

9. The system of claim 8, wherein
said left sound path comprises an acoustic cavity resonator configured to amplify one or more frequencies of said audio from said left speaker; and,
said right sound path comprises an acoustic cavity resonator configured to amplify one or more frequencies of said audio from said right speaker.

10. The system of claim 1, further comprising at least one vibration actuator located in one or both of said goggle assembly and said headband.

11. The system of claim 1, wherein said goggle assembly further comprises an intraocular distance adjustment mechanism configured to adjust a distance between said left lens and said right lens.

12. The system of claim 11, wherein said intraocular distance adjustment mechanism is further configured to
obtain a desired intraocular distance for said user from a database;
actuate a relative motion between said left lens and said right lens to make said distance between said left lens and said right lens substantially equal to said desired intraocular distance for said user.

13. The system of claim 12, wherein said intraocular distance adjustment mechanism comprises
a motor;
a worm wheel coupled to a shaft of said motor; and,
a worm screw coupled to said worm wheel and coupled to said left lens and said right lens.

14. The system of claim 12, further comprising an intraocular distance calibration mechanism configured to measure said desired intraocular distance for said user.

15. The system of claim 1, further comprising:
a power supply assembly configured to be coupled to a part of said user's body other than said user's head; and,
a power cable coupled to said power supply assembly and coupled to one or both of said goggle assembly and said headband.

16. The system of claim 15, wherein said power supply assembly comprises
a collar configured to be coupled to said user's neck, wherein said collar comprises one or more batteries.

17. The system of claim 1, wherein said goggle assembly is configured for augmented reality.

18. The system of claim 1, wherein said goggle assembly is configured for mixed reality.

19. A virtual reality headset that enables use with a rear head support, comprising:
a goggle assembly comprising
a housing configured to conform to a user's face, wherein a left edge of said housing is in front of said user's left ear, and a right edge of said housing is in front of said user's right ear;
at least one display coupled to an inner surface of said housing and located between said housing and said user's face;
a left lens coupled to said housing and located between said at least one display and a left eye of said user; and,
a right lens coupled to said housing and located between said at least one display and a right eye of said user;
an intraocular distance adjustment mechanism configured to
obtain a desired intraocular distance for said user from a database; and,
actuate a relative motion between said left lens and said right lens to make said distance between said left lens and said right lens substantially equal to said desired intraocular distance for said user;
a left side expansion spring; and,
a right side expansion spring;
a headband configured to conform to a back side of said user's head and secure said goggle assembly to said user's head when said user's head is supported from the rear or side, wherein
said headband comprises a compliant inner surface material configured to contact a back of said user's head; and,
said compliant inner surface material comprises an Indentation Load Deflection rating of 10 pounds or less;
a left connector coupled to a left side of said headband and to said left side expansion spring;
a right connector coupled to a right side of said headband and to said right side expansion spring;
at least one vibration actuator located in one or both of said goggle assembly and said headband;
a left speaker coupled to said left side of said goggle assembly or to said left side of said headband;
a right speaker coupled to said right side of said goggle assembly or to said right side of said headband;
a left side sound path located in said left side of said goggle assembly or said left side of said headband and configured to direct audio from said left speaker towards said user's left ear;
a right side sound path located in said right side of said goggle assembly or said right side of said headband and configured to direct audio from said right speaker towards said user's right ear;
a power supply assembly comprising one or more batteries and configured to be coupled to a part of said user's body other than said user's head; and,
a power cable coupled to said power supply assembly and coupled to one or both of said goggle assembly and said headband.

20. The system of claim 19, wherein said goggle assembly is configured for augmented reality or mixed reality.
